(19) United States
(12) Patent Application Publication
(10) Pub. No.: US 2018/0210255 A1
(43) Pub. Date: Jul. 26, 2018

(54) ARRAY SUBSTRATE AND TOUCH-SENSITIVE DISPLAY DEVICE

(71) Applicant: Wuhan China Star Optoelectronics Technology Co., Ltd., Wuhan, Hubei (CN)

(72) Inventors: Yao-li HUANG, Shenzhen, Guangdong (CN); Hongsen ZHANG, Shenzhen, Guangdong (CN)

(73) Assignee: Wuhan China Star Optoelectronics Technology Co., Ltd., Wuhan, Hubei (CN)

(21) Appl. No.: 15/317,400

(22) PCT Filed: Aug. 10, 2016
(86) PCT No.: PCT/CN2016/094464

§ 371 Date: Dec. 8, 2016

(30) Foreign Application Priority Data
Jul. 19, 2016 (CN) 201610567467.3

(51) Int. Cl. G02F 1/1333; G02F 1/1335; G02F 1/1362; G06F 3/041; G06F 3/047

(52) U.S. Cl. CPC G02F 1/13338; G02F 1/133512; G06F 3/047; G06F 3/0412; G02F 1/136286

(57) ABSTRACT

The invention provides an array substrate at least including a substrate, and a display area and a non-display area provided on the substrate. The display area has multiple spacedly-disposed touch electrodes and touch wires electrically connected with touch electrodes. The non-display area has a touch driver, peripheral wires electrically connected to the touch driver, and a first metal wire and a second metal wire insulated from each other. The touch wires are connected with the peripheral wires. The peripheral wires are each connected in parallel with at least one of the first metal wire and the second metal wire. The invention further provides a touch-sensitive display device.

### CROSS REFERENCE TO RELATED APPLICATION

This application claims the priority of Chinese Patent Application No. 201610567467.3, entitled “Array Substrate and Touch-sensitive Display Device”, filed on Jul. 19, 2016, the disclosure of which is incorporated herein by reference in its entirety.

### FIELD OF THE INVENTION

The invention relates to the field of touch-sensitive display, and more particularly to an array substrate and a touch-sensitive display device.

### BACKGROUND OF THE INVENTION

With the increasing deepening of intense degree of competition in the smart phone market, products with the integration of touch and display functions (shorted as touch-display integration) usher in a new round of competition. An in-cell technology is regarded as a high-end technology in the field and is widely sought. The so-called in-cell technology is that a touch panel function is embedded into liquid crystal pixels.

The touch technology after rapid development has become a standard configuration in mobile phones and other consumer goods, and the in-cell touch technology is also gradually applied to mobile phone terminals, because the in-cell touch technology integrates a touch function with a display function together, i.e., a touch circuit and a display circuit both are disposed on a TFT substrate, such design is in favor of transmittance enhancement and would make mobile phones be more light and slim. The in-cell touch technology is classified into a self-capacitance type and a mutual-capacitance type, although principles of which are different, key parameters affecting a touch performance ultimately are load resistance and capacitance, and usually the resistance and capacitance loads of the touch panel should be as small as possible. A touch wire outside of a touch area in a conventional in-cell touch panel generally adopts a single metal wire, and a design of touch point in the touch area generally is certain, that is the resistance and capacitance in the touch area generally cannot be changed, which would affect the touch performance.

### SUMMARY OF THE INVENTION

An objective of the invention is to provide an array substrate, and the array substrate makes full use of metal wires outside of a display area to reduce resistance of a touch panel and thereby improve touch performance.

Another objective of the invention is to provide a touch-sensitive display device with the array substrate.

In order to achieve the above objectives, embodiments of the invention provide the following technical solutions:

The array substrate at least includes a substrate, and a display area and a non-display area provided on the substrate. The display area has multiple (i.e., more than one) spacedly-disposed touch electrodes and touch wires electrically connected with the touch electrodes. The non-display area has a touch driver, peripheral wires electrically connected to the touch driver, and a first metal wire and a second metal wire insulated from each other. The touch wires are connected with the peripheral wires. The peripheral wires are each connected in parallel with at least one of the first metal wire and the second metal wire.

In an embodiment, projections of the peripheral wire and the first metal wire on the substrate are staggeredly disposed. The peripheral wire, the first metal wire and the second metal wire are connected in parallel.

In an embodiment, projections of the peripheral wire and the second metal wire on the substrate are staggeredly disposed. The peripheral wire, the first metal wire and the second metal wire are connected in parallel.

In an embodiment, the display area includes a pixel unit, the first metal wire is configured as a scan line or a data line of the pixel unit, and the peripheral wire is connected in parallel with the second metal wire.

In an embodiment, the display area includes a pixel unit, the second metal wire is configured as a scan line or a data line of the pixel unit, and the peripheral wire is connected in parallel with the first metal wire.

In an embodiment, the first metal wire is a data line and the second metal wire is a scan line; or the second metal wire is the data line and the first wire is the scan line.

In an embodiment, the peripheral wire is connected to the first metal wire and the second metal wire by via holes.

In an embodiment, the first metal wire, the second metal wire and the peripheral wire are respectively disposed on three successively stacked insulating layers.

In an embodiment, the substrate is provided with a sensing layer, the sensing layer is an insulating layer, and the touch wires are metal wires disposed on the sensing layer.

The touch-sensitive display device includes the array substrate according to any one of the above embodiments.

Advantages and beneficial effects can be achieved by the invention are that: in the invention, the peripheral wires are designed to be connected in parallel with the first metal wire and/or the second metal wire, which can reduce resistance of each of the touch wires to the maximum degree and is beneficial to improve touch performance of panel.

### BRIEF DESCRIPTION OF THE DRAWINGS

In order to more clearly illustrate technical solutions of embodiments of the invention or the prior art, drawings will be used in the description of embodiments or the prior art will be given a brief description below. Apparently, the drawings in the following description only are some of embodiments of the invention, the ordinary skill in the art can obtain other drawings according to these illustrated drawings without creative effort.

FIG. 1 is a schematic plan view of an array substrate of the invention.

FIG. 2 is a schematic partial cross-sectional view of a first embodiment of the array substrate as shown in FIG. 1.

FIG. 3 is a schematic partial cross-sectional view of a second embodiment of the array substrate as shown in FIG. 1.

FIG. 4 is a structural schematic view of a touch-sensitive display device of the invention.

### DETAILED DESCRIPTION OF THE PREFERRED EMBODIMENTS

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

In the description of the invention, it is noted that, unless otherwise clearly defined and limited, terms “installing”, “connecting with”, “connected”, should be broadly understood, for example, it may be fixedly connected, may be detachably connected or integrally connected; it may be mechanically connected; it may be directly connecting with, may be indirectly connecting with by an intermediary, may be internally communicated between two elements. For those ordinary skills in the art, specific meanings of the above terms in the invention can be understood according to specific situations.

In addition, in the description of the invention, unless otherwise indicated, “multiple/a plurality of” means two or more than two. If the specification appears the term “step”, it not only means an individual process, when it cannot distinguish from the other step, as long as it can realize the intended function of the step, it should be included in the term. Furthermore, in this specification, a numerical range expressed by “˜” means a range containing values before and after “˜” respectively as the minimum value and the maximum value. In the drawings, units with similar or same structures are denoted by same reference numerals.

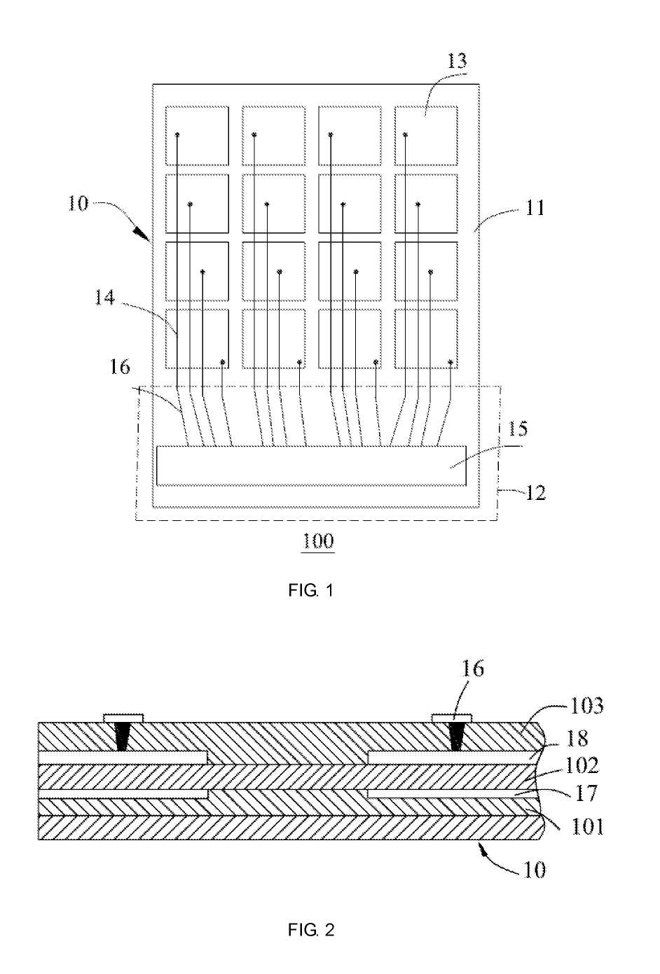

Please refer to FIG. 1 and FIG. 2, an array substrate 100 of the invention at least includes a substrate 10, and a display area 11 and a non-display area 12 disposed on the substrate 10. The display area 11 has multiple spacedly-disposed touch electrodes 13 and touch wires 14 electrically connected with the touch electrodes 13.The non-display area 12 has a touch driver 15, peripheral wires 16 electrically connected to the touch driver 15, and a first metal wire 17 and a second metal wire 18 insulated from each other. The touch wires 14 are connected with the peripheral wires 16. The peripheral wires 16 are each connected in parallel with at least one of the first metal wire 17 and the second metal wire 18.

The peripheral wires 16 and the touch electrodes 13 are corresponded with each other in one by one manner. Each of the touch electrodes 13 is electrically connected to the touch driver 15 by the peripheral wire 16. More particularly, each of the touch electrode 13 may be connected with at least two touch wires, and for multiple touch wires 14 corresponding to any one of the touch electrodes 13, at least two of the multiple touch wires 14 are connected in parallel and then connected to the peripheral wire 16 and thereby connected to the touch driver 15 by the peripheral wire 16. By disposing multiple touch wires 14 to connect with the peripheral wire 16, it can improve stability of connection and reduce the failure caused by disconnection of single touch wire 14.

Furthermore, the first metal wire 17, the second metal wire 18 and the peripheral wire 16 are respectively disposed on three successively stacked insulating layers. More particularly, the substrate 10 further includes a first insulating layer 101, a second insulating layer 102 and a third insulating layer 103 successively stacked in that order. The first metal wire 17, the second metal wire 18 and the peripheral wire 16 are respectively disposed on the first insulating layer 101, the second insulating layer 102 and the third insulating layer 103. In a first embodiment of the invention, the display area includes a pixel unit, the first metal wire 17 is configured as a scan line or a data line of the pixel unit, and the peripheral wire 16 is connected in parallel with the second metal wire 18. More particularly, the peripheral wire 16 is connected in parallel with the second metal wire 18 by via holes. The second metal wire 18 connected in parallel with the peripheral wire 16 is disposed in the non-display area 12.

The peripheral wires 16 of the array substrate 100 of the invention are each connected in parallel with the first metal wire or the second metal wire, which can reduce resistance of each the touch wire to the maximum degree and is advantage to improve touch performance of panel. Furthermore, when a wire width and a film thickness of the touch wire are fixed, in case of a single layer of peripheral wire satisfying the touch performance, a film thickness of the peripheral wire can be reduced so as to reduce manufacturing cost. Meanwhile, it can improve the touch performance of touch panel while no increasing of additional step and photomask.

In an exemplary embodiment, a sensing layer (not shown in the drawing) disposed on the substrate 10 is located in the display area, and the touch wires 14 are metal wires disposed on the sensing layer. In an embodiment of the invention, a material of the touch wires 14 is a transparent conductive material or a metal material. Preferably, the material of the touch wires 14 is the transparent conductive material, e.g., indium tin oxide (referred to as ITO), indium zinc oxide (referred to as IZO) or a combination thereof.

Furthermore, the first metal wire 17 is a data line and the second metal wire 18 is a scan line. Or, the second metal wire 18 is the data line and the first metal wire 17 is the scan line instead. In an exemplarily illustrated embodiment, the first metal wire 17 is the data line and the second metal wire 18 is the scan line. The first metal layer, the second metal layer and the peripheral wires may be made of a same metal material.

In another embodiment of the invention, differences from the first embodiment are that the second metal wire 18 is configured as a data line or a scan line for a pixel unit, and the peripheral wires 16 are each connected in parallel with the first metal wire 17.

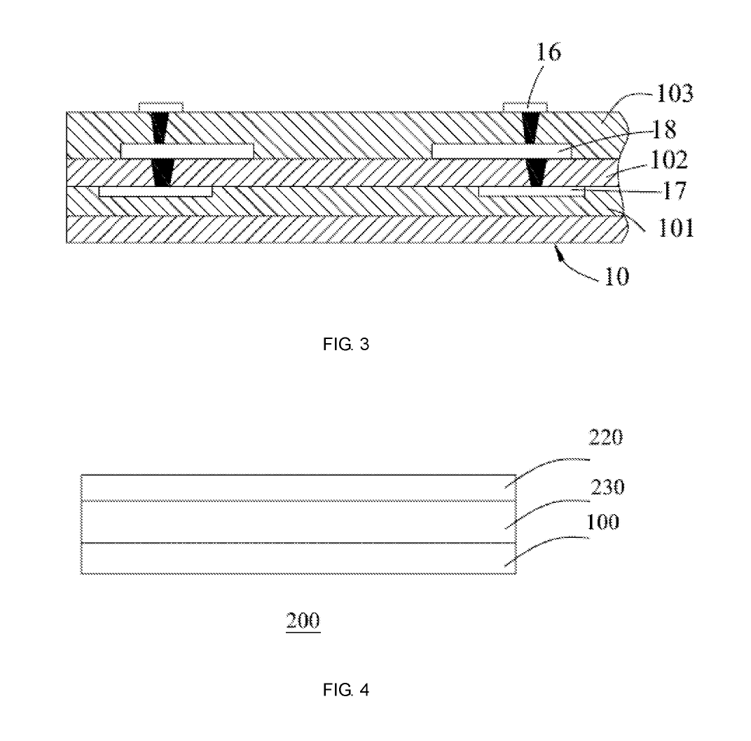

Please refer to FIG. 3, in a second embodiment of the invention, projections of the peripheral wire 16 and the first metal wire 17 on the substrate 10 are staggeredly disposed. The peripheral wire 16, the first metal wire 17 and the second metal wire 18 are connected in parallel. Furthermore, the peripheral wire 16 is connected to the first metal wire 17 and the second metal wire 18 by via holes. More particularly, in an staggered area of the projections of the peripheral wire 16 and the first metal wire 17 on the substrate 10, there is an enough space to facilitate two ends of the peripheral wire 16 to be disposed with via holes and thereby the peripheral wire 16 being connected in parallel with the first metal wire 17 as well as the second metal wire 18 by the via holes.

In yet another embodiment of the invention, projections of the peripheral wire 16 and the second metal wire 18 on the substrate 10 are staggeredly disposed, and the peripheral wire 16, the first metal wire 17 and the second metal wire 18 are connected in parallel.

Based on the above array substrate, referring to FIG. 4, the invention further provides a touch-sensitive display device 200. In the illustrated embodiment, the touch-sensitive display device includes the array substrate 100 as described in any one of the above embodiments, a color filter substrate 220 disposed opposite to the array substrate 100, and a liquid crystal layer 230 disposed between the array substrate 100 and the color filter substrate 220. A color filter layer (not shown in the drawing) is disposed on the color filter substrate 220, and the color filter layer specifically is disposed on a side of the color filter substrate 220 facing towards the liquid crystal layer 230.

The foregoing embodiments of the invention are not construed as limiting to the protection scope of the invention, any modification, equivalent replacement, improvement and the like made within the spirit and principles of the foregoing embodiments should be included within the protection scope of the invention.

What is claimed is:

1. An array substrate at least comprising a substrate, and a display area and a non-display area disposed on the substrate; wherein the display area is disposed with a plurality of spacedly-disposed touch electrodes and touch wires electrically connected with the plurality of touch electrodes; the non-display area is disposed with a touch driver, peripheral wires electrically connected to the touch driver, and a first metal wire and a second metal wire spaced from each other; the touch wires are connected with the peripheral wires; the peripheral wires are each connected in parallel with at least one of the first metal wire and the second metal wire.

2. The array substrate according to claim 1, wherein projections of the peripheral wire and the first metal wire on the substrate are staggeredly disposed; the peripheral wire, the first metal wire and the second metal wire are connected in parallel.

3. The array substrate according to claim 1, wherein projections of the peripheral wire and the second metal wire on the substrate are staggeredly disposed; the peripheral wire, the first metal wire and the second metal wire are connected in parallel.

4. The array substrate according to claim 1, wherein the display area comprises a pixel unit, the first metal wire is configured as a scan line or a data line for the pixel unit, and the peripheral wire is connected in parallel with the second metal wire.

5. The array substrate according to claim 1, wherein the display area comprises a pixel unit, the second metal wire is configured as a scan line or a data line for the pixel unit, and the peripheral wire is connected in parallel with the first metal wire.

6. The array substrate according to claim 1, wherein the first metal wire is a data line and the second metal wire is a scan line; or the second metal wire is the data line and the first wire is the scan line.

7. The array substrate according to claim 2, wherein the peripheral wire is connected to the first metal wire and the second metal wire by via holes.

8. The array substrate according to claim 6, wherein the first metal wire, the second metal wire and the peripheral wire are respectively disposed on three successively stacked insulating layers.

9. The array substrate according to claim 1, wherein the substrate is disposed with a sensing layer, the sensing layer is an insulating layer, and the touch wires are metal wires disposed on the sensing layer.

10. A touch-sensitive display device comprising an array substrate, a color filter substrate and a liquid crystal layer interposed between the array substrate and the color filter substrate; wherein the array substrate at least comprises a substrate, and a display area and a non-display area provided on the substrate;
the display area has a plurality of spacedly-disposed touch electrodes and touch wires electrically connected with the plurality of touch electrodes; the non-display area has a touch driver, peripheral wires electrically connected to the touch driver, and a first metal wire and a second metal wire insulated from each other; the touch wires are connected with the peripheral wires; the peripheral wires are each connected in parallel with at least one of the first metal wire and the second metal wire.

11. The touch-sensitive display device according to claim 10, wherein projections of the peripheral wire and the first metal wire on the substrate are staggeredly disposed; the peripheral wire, the first metal wire and the second metal wire are connected in parallel.

12. The touch-sensitive display device according to claim 10, wherein projections of the peripheral wire and the second metal wire on the substrate are staggeredly disposed; the peripheral wire, the first metal wire and the second metal wire are connected in parallel.

13. The touch-sensitive display device according to claim 10, wherein the display area comprises a pixel unit, the first metal wire is configured as a scan line or a data line for the pixel unit, and the peripheral wire is connected in parallel with the second metal wire.

14. The touch-sensitive display device according to claim 10, wherein the display area comprises a pixel unit, the second metal wire is configured as a scan line or a data line for the pixel unit, and the peripheral wire is connected in parallel with the first metal wire.

15. The touch-sensitive display device according to claim 10, wherein the first metal wire is a data line and the second metal wire is a scan line; or the second metal wire is the data line and the first wire is the scan line.

16. The touch-sensitive display device according to claim 11, wherein the peripheral wire is connected to the first metal wire and the second metal wire by via holes.

17. The touch-sensitive display device according to claim 15, wherein the first metal wire, the second metal wire and the peripheral wire are respectively disposed on three successively stacked insulating layers.

18. The touch-sensitive display device according to claim 10, wherein the substrate is disposed with a sensing layer, the sensing layer is an insulating layer, and the touch wires are metal wires disposed on the sensing layer.
